(19) United States
(12) Patent Application Publication
(10) Pub. No.: US 2011/0305336 A1
(43) Pub. Date: Dec. 15, 2011

(54) INFORMATION PROCESSING APPARATUS, SERVER APPARATUS, INFORMATION PROCESSING METHOD AND PROGRAM THEREFOR

(75) Inventor: Kuniyuki Manaka, Tokyo (JP)

(73) Assignee: SONY CORPORATION, Tokyo (JP)

(21) Appl. No.: 13/152,880

(22) Filed: Jun. 3, 2011

(30) Foreign Application Priority Data
Jun. 10, 2010 (JP) P2010-132548

(51) Int. Cl. H04L 9/00

(52) U.S. Cl. 380/255; 380/277

(57) ABSTRACT

Provided is an information processing apparatus including a board on which electronic components are provided, a content encryption section configured to encrypt a content with a device key, a first storage section which is provided as one of the electronic components on the board and is capable of storing first identification information specific to the board, the first identification information being used to generate the device key, a transfer section configured to transfer the first identification information through a network to a server apparatus capable of storing the first identification information, and a first acquisition section configured to acquire the first identification information through the network from the server apparatus.

### CROSS-REFERENCE TO RELATED APPLICATION

The present application claims priority from Japanese Patent Application No. JP 2010-132548 filed in the Japanese Patent Office on Jun. 10, 2010, the entire content of which is incorporated herein by reference.

### BACKGROUND OF THE INVENTION

The present disclosure relates to an information processing apparatus capable of managed copying contents, a server apparatus connectable to the information processing apparatus through a network, an information processing method by the information processing apparatus, and a program therefor.

In recent years, a managed copy (MC) technology has been known that enables recording and copying of contents recorded in recording media such as a Blue-ray Disc (trademark) or the like in a storage section such as a Hard Disk Drive (HDD) or the like, under predetermined conditions. In order for a user's information processing apparatus to copy a content recorded in a recording medium through this managed copy, first the information processing apparatus is connected by way of a network to a server apparatus which manages managed copies, and information necessary for acquisition of a permission to copy the content is exchanged between the information processing apparatus and the server apparatus. Going through the exchange of the necessary information with the user's information processing apparatus, the server apparatus judges validity of the copying permission. Then, the information processing apparatus encrypts the content using an apparatus specific key (device key), and saves the encrypted content as a copied content in the storage section.

When playing the copied encrypted content, the information processing apparatus deactivates the encryption with the device key and plays the content. The device key is stored in a storage apparatus on a board of the information processing apparatus.

If the board is replaced due to a repair of the information processing apparatus or the like, the device key stored in the storage apparatus on the board before replacement will be lost. Thus, although the information processing apparatus after the replacement of the board is the same information processing apparatus for the user, the board and the device key stored on the board will differ from those before the replacement. Consequently, a problem occurs that the information processing apparatus after the replacement of the board may not play encrypted contents by the device key stored on the board before the replacement. Under these circumstances, in order for the information processing apparatus after the replacement of the board to play the content managed copied before the replacement of the board, it is common to perform managed copying again by using a new device key.

Thus, in an information processing apparatus of Japanese Patent Application Laid-open No. 2007-195110 (Paragraph [0065], FIG. 6) (hereinafter, referred to as Patent Document 1), there are provided copyright protection Large Scale Integration (LSI) in which Electrically Erasable Programmable Read Only Memory (EEPROM) including a key and key restoration data is provided, and a system board in which EEPROM including key restoration data is provided. When the copyright protection LSI is replaced, the key restoration data is copied from the EEPROM of the system board to the copyright protection LSI after replacement.

### SUMMARY OF THE INVENTION

However, in the method of Patent Document 1, additional EEPROM including key restoration data is necessary. In addition, there should be at least two boards on which EEPROM is provided, and thus an information processing apparatus including only one board may not cope with the method. In addition, when both EEPROM are broken, copying process for key restoration may also be impossible. Further, as the process of copying key restoration data involves manual work such as copying with a specific tool or the like, only a secure service center limited to repairing can handle it.

In view of the above-mentioned circumstances, there is a need for providing an information processing apparatus for which a device key can be restored easily and safely.

According to an embodiment of the present disclosure, there is provided an information processing apparatus including a board on which electronic components are provided, a content encryption section, a first storage section, a transfer section, and a first acquisition section.

The content encryption section encrypts a content with a device key.

The first storage section is provided as one of the electronic components on the board and is capable of storing first identification information specific to the board, the first identification information being used to generate the device key.

The transfer section transfers the first identification information through a network to a server apparatus capable of storing the first identification information.

The first acquisition section acquires the first identification information through the network from the server apparatus.

According to the information processing apparatus after replacement of the board can restore downloaded first identification information, and generate the device key by using the restored first identification information. Consequently, the information processing apparatus after replacement of the board can also perform managed copying or play managed copied contents, by using the device key specific to the board before replacement. In addition, as the device key itself is neither transferred through the network nor stored in the server apparatus, the device key will not leak from the information processing apparatus. Should the first identification information leak, the device key may not be generated unless the first identification information can be restored. Hence, it is safe.

The information processing apparatus may further include an identification information encryption section configured to encrypt the first identification information, and an identification information decryption section configured to decrypt the encrypted first identification information.

The transfer section may transfer the encrypted first identification information through the network to the server apparatus.

The first acquisition section may acquire the first identification information through the network from the server apparatus.

The first identification information is encrypted before the first identification information is transferred/acquired with respect to the server apparatus through the network, and hence safety is further enhanced.

The information processing apparatus may further include a second storage section configured to store second identification information specific to the information processing apparatus.

The server apparatus may be capable of associating the encrypted first identification information with the second identification information and storing the encrypted first identification information and the second identification information.

The transfer section may further transfer the second identification information through the network to the server apparatus.

The first acquisition section may acquire the first identification information, which is encrypted by the server apparatus while being associated with the second identification information, through the network.

The server apparatus associates the first identification information with the second identification information and stores them, and hence the information processing apparatus to which the board after replacement is mounted can restore the first identification information specific to the board before replacement, easily and safely.

The first storage section may further store third identification information specific to a firmware.

The information processing apparatus may further include a key generation section configured to generate the device key on a basis of the first identification information and the third identification information.

The first storage section may be capable of selectively storing the first identification information and fourth identification information specific to the board, the fourth identification information being used to acquire the encrypted first identification information through the network from the server apparatus.

The identification information encryption section may further encrypt the fourth identification information stored in the first storage section,

The server apparatus may be further capable of storing the encrypted fourth identification information.

The transfer section may transfer the second identification information through the network to the server apparatus when the transfer section further transfers the encrypted fourth identification information to the server apparatus through the network, and acquires an authentication of the encrypted fourth identification information from the server apparatus.

The first storage section may further rewrite the fourth identification information stored in the first storage section to the first identification information.

The authentication is performed by using the fourth identification information being identification information specific to the board after replacement, and hence it is possible to authenticate that the board after replacement is not falsified one or the like, but authentic one before performing downloading of the first identification information.

The first storage section may be further capable of storing fifth identification information specific to the board to be identified by use of the fourth identification information.

The server apparatus may be capable of associating the encrypted fourth identification information with the fifth identification information, and storing the encrypted fourth identification information and the fifth identification information.

The transfer section may associate the encrypted fourth identification information with the fifth identification information and transfers the encrypted fourth identification information and the fifth identification information through the network to the server apparatus.

The authentication is performed by using the fourth identification information and the fifth identification information, which are identification information specific to the board after replacement, and hence it is possible to authenticate that the board after replacement is not falsified one or the like, but authentic one before performing downloading of the first identification information.

According to an embodiment of the present disclosure, there is provided a server apparatus including a third storage section, a second acquisition section, an authentication section, and a supply section.

The server apparatus is connectable to an information processing apparatus including a board on which electronic components are provided, a content encryption section configured to encrypt a content with a device key, a first storage section which is provided as one of the electronic components on the board and is capable of storing first identification information specific to the board, the first identification information being used to generate the device key, and a second storage section configured to second identification information specific to the information processing apparatus.

The third storage section is capable of associating the first identification information and the second identification information each other and storing the first identification information and the second identification information.

The second acquisition section acquires the second identification information through a network from the information processing apparatus.

The authentication section judges whether the acquired second identification information is stored in the third storage section.

The supply section supplies the first identification information, which is stored in the third storage section while being associated with the second identification information, through the network to the information processing apparatus when the authentication section judges that the acquired second identification information is stored in the third storage section.

According to an embodiment of the present disclosure, there is provided an information processing method by an information processing apparatus including a board on which electronic components are provided, a content encryption section configured to encrypt a content with a device key, and a first storage section which is provided as one of the electronic components on the board and is capable of storing first identification information specific to the board, the first identification information being used to generate the device key.

The first identification information is transferred by a transfer section through a network to a server apparatus capable of storing the first identification information.

The first identification information is acquired by a first acquisition section through the network from the server apparatus.

According to an embodiment of the present disclosure, there is provided a program causing an information processing apparatus including a board on which electronic components are provided, a content encryption section configured to encrypt a content with a device key, and a first storage section which is provided as one of the electronic components on the board and is capable of storing first identification information specific to the board, the first identification information being used to generate the device key, to function as:
a transfer section configured to transfer the first identification information through a network to a server apparatus capable of storing the first identification information; and
a first acquisition section configured to acquire the first identification information through the network from the server apparatus.

According to the embodiments of the present disclosure, a device key can be restored easily and safely.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a view showing an entire configuration of an information processing system according to a first embodiment of the present disclosure;

FIG. 2 is a block diagram showing a hardware configuration of an information processing apparatus;

FIG. 3 is a block diagram showing a hardware configuration of a server apparatus;

FIG. 4 is a block diagram showing a functional configuration of the information processing apparatus;

FIG. 5 is a block diagram showing a functional configuration of the server apparatus;

FIG. 6 is a flow chart showing a process of generating a device key;

FIG. 7 is a flow chart showing a process of restoring Seed A;

FIG. 8 is a schematic view showing the information processing system;

FIG. 9 is a flow chart showing a process of restoring Seed A according to a second embodiment of the present disclosure;

FIG. 10 is a schematic view showing the information processing system before replacement of board;

FIG. 11 is a schematic view showing the information processing system after replacement of board;

FIG. 12 is a flow chart showing a process of restoring Seed A according to a third embodiment of the present disclosure;

FIG. 13 is a schematic view showing the information processing system before replacement of board; and

FIG. 14 is a schematic view showing the information processing system after replacement of board.

### DETAILED DESCRIPTION OF EMBODIMENTS

Hereinafter, embodiments of the present disclosure will be described with reference to the drawings.

### <First Embodiment>

### [Configuration of Information Processing System]

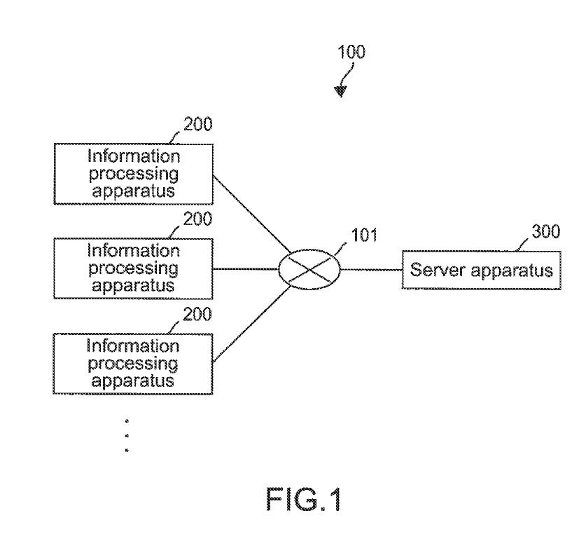

FIG. 1 is a view showing an entire configuration of an information processing system according to a first embodiment of the present disclosure.

An information processing system 100 includes one or more information processing apparatuses 200 and a server apparatus 300. The information processing apparatuses 200 and the server apparatus 300 are connected to communicate to each other through a global network 101.

Each of the information processing apparatuses 200 is capable of managed copying and includes a record reproducer such as a Blu-ray Disc (trademark) player. The information processing apparatus 200 exchanges information necessary for acquiring a permission to copy a content with a management server through a network. When the management server acknowledges validity of copying permission, the information processing apparatus 200 encrypts the content with a device key, and saves the encrypted content in an external storage apparatus. When playing the encrypted content, the information processing apparatus 200 deactivates the encryption with the device key and plays the content. It should be noted that in the following, only one of the information processing apparatuses 200 will be described.

The server apparatus 300 is capable of associating encryption information of information specific to a board to be used to generate a key (device key) specific to the board of the information processing apparatus 200 with information specific to a main body of the information processing apparatus 200 and storing them.

### [Hardware Configuration of Information Processing Apparatus]

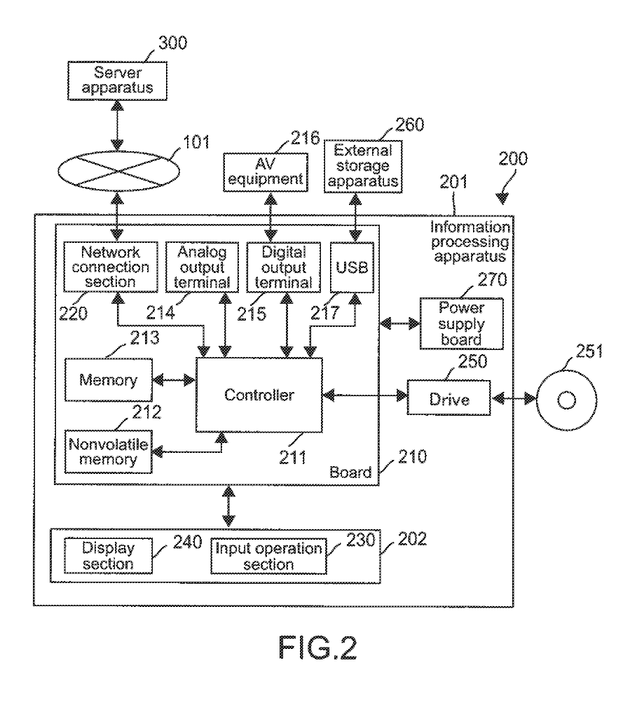

FIG. 2 is a block diagram showing a hardware configuration of the information processing apparatus.

The information processing apparatus 200 includes a controller 211, a nonvolatile memory 212, a main memory 213, an analog output terminal 214, a digital output terminal 215, a Universal Serial Bus (USB) connection section 217, a network connection section 220, an input operation section 230, a display section 240, a drive section 250, and a power supply board 270. To the USB connection section 217, an external storage apparatus 260 is connected.

The controller 211, the nonvolatile memory 212, the main memory 213, the analog output terminal 214, the digital output terminal 215, the USB connection section 217, and the network connection section 220 are implemented on one board 210. The board 210 is removable from the main body 201 of the information processing apparatus 200 and can be replaced. The board 210 is removed from the main body 201 when a device implemented on the board 210 fails, for example. A board 210 after replacement can be mounted on the main body 201 of the information processing apparatus 200.

The controller 211 not only performs overall control of the respective sections mentioned above but also controls exchange of data among the respective sections. In order to execute software processing to be executed by the information processing apparatus 200, the controller 211 loads a program from the external storage apparatus 260 or the nonvolatile memory 212 to the main memory 213, interprets, and runs it. The controller 211 functions as an encoder and a decoder.

The nonvolatile memory 212 is a firmware for controlling a computer system (hardware) embedded in the information processing apparatus 200 or a rewritable read-only memory which permanently stores information specific to the board 210. The nonvolatile memory 212 is a NAND type flash memory, for example.

The main memory 213 is a memory to be used to load a program code to be executed by the controller 211 or to write program work data. The main memory 213 is a Double-Data-Rate Dynamic Random Access Memory (DDR DRAM), for example.

The analog output terminal 214 and the digital output terminal 215 are interfaces to which Audio Visual (AV) equipment 216 capable of outputting video and audio can be connected. The digital output terminal 215 is a High-Definition Multimedia Interface (HDMI) terminal, for example. The AV equipment 216 is a television set, a monitor, or a speaker, for example. It should be noted that the information processing apparatus 200 may be a Personal Computer (PC) which is integrally formed with the AV equipment 216.

The network connection section 220 processes a wired or wireless connection to the global network 101. The network connection section 220 serves as a transmission section 221 (to be described later) configured to transmit information through the network 101 to the server apparatus 300 and as a reception section 222 (to be described later) configured to acquire information through the network 101 from the server apparatus 300.

The input operation section 230 and the display section 240 are provided on a front panel 202 of the main body 201 of the information processing apparatus 200. The input operation section 230 includes various keys and the like. A user enters various instructions by using the input operation section 230. An instruction entered in the input operation section 230 by the user is supplied to the controller 211.

The display section 240 is a display apparatus using a Liquid Crystal Display (LCD), an Electro-Luminescence (EL) or the like.

The drive section 250 is a device capable of driving a removable recording medium 251 such as a Blu-ray Disc (trademark) or a Digital Versatile Disc (DVD).

The external storage apparatus 260 is capable of permanently storing contents copied from the recording medium 251. The external storage apparatus 260 is an HDD or a Solid State Drive (SDD), for example. In addition, a storage apparatus built in the information processing apparatus 200 may replace the external storage apparatus 260.

The power supply board 270 is a board on which a power supply circuit for supplying necessary electric power to the respective sections of the information processing apparatus 200 is mounted.

### [Hardware Configuration of Server Apparatus]

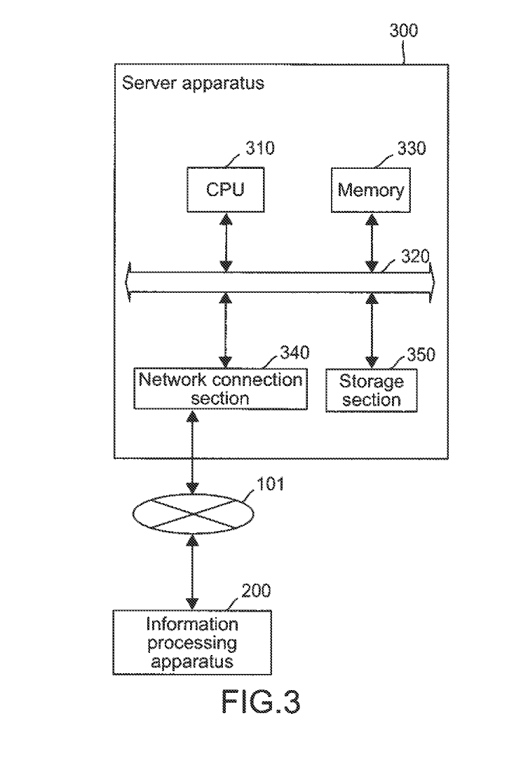

FIG. 3 is a block diagram showing a hardware configuration of the server apparatus.

The server apparatus 300 includes a CPU (Central Processing Unit) 310, a main memory 330, a network connection section 340, a storage section 350, and a system bus 320 configured to connect those devices to each other.

The CPU 310 not only performs overall control of the respective sections mentioned above but also controls exchange of data among the respective sections. In order to execute software processing to be executed by the server apparatus 300, the CPU 310 loads a program from the storage section 350 to the main memory 330, interprets, and runs it.

The main memory 330 is a volatile memory to be used to load a program code to be executed by the CPU 310 or to write program work data.

The network connection section 340 processes wired or wireless connection with the global network 101. To the network 101, the information processing apparatus 200 is connected in a wired or wireless manner. The network connection section 340 serves as a transmission section 342 (to be described later) configured to transmit information through the network 101 to the information processing apparatus 200 and as a reception section 341 (to be described later) configured to acquire information through the network 101 from the information processing apparatus 200.

The storage section 350 is a firmware for controlling a computer system (hardware) embedded in the server apparatus 300 or a rewritable read-only memory which permanently stores information specific to the board 210.

### [Functional Configuration of Information Processing Apparatus]

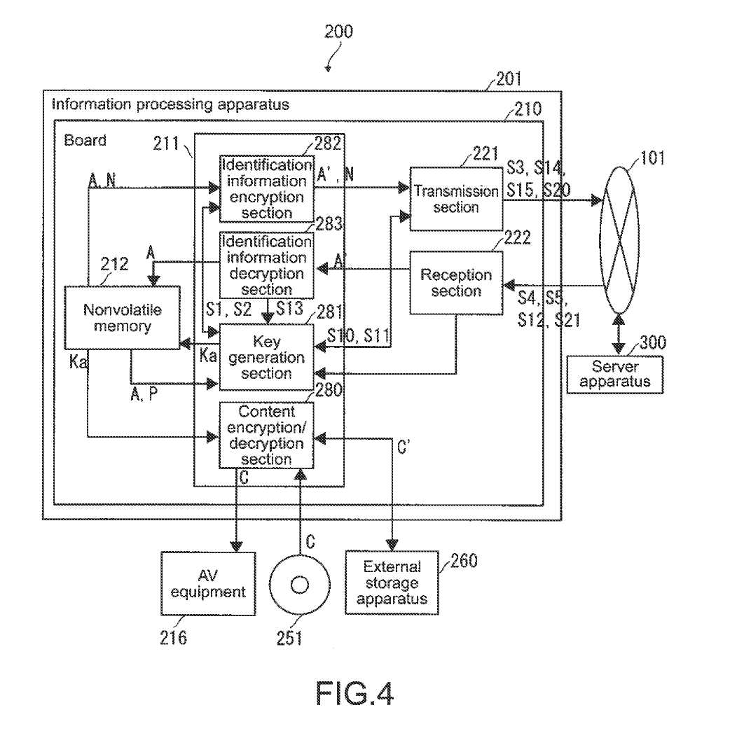

FIG. 4 is a block diagram showing a functional configuration of the information processing apparatus.

The information processing apparatus 200 includes a nonvolatile memory 212, a content encryption/decryption section 280, a key generation section 281, an identification information encryption section 282, a transmission section 221, a reception section 222, and an identification information decryption section 283. The content encryption/decryption section 280, the key generation section 281, the identification information encryption section 282, and the identification information decryption section 283 are realized through a controller 211. The nonvolatile memory 212 and the controller 211 are implemented on the board 210.

The nonvolatile memory 212 rewritably stores Seed A (first identification information), a device key Ka, and an apparatus serial N (second identification information). The nonvolatile memory 212 further stores Seed P (third identification information) and a Uniform Resource Locator (URL) of the server apparatus 300 while being recorded in the firmware which controls the board 210.

The Seed A is identification information specific to the board 210, and is generated and written when the board 210 is manufactured. The Seed A is used to generate the device key Ka.

The device key Ka is used to encrypt a content recorded in a recording medium 251 or to decrypt an encrypted content, in managed copying. It should be noted that rather than being stored in the nonvolatile memory 212, the device key Ka may be generated by the key generation section 281 from the Seed A and the Seed P at the time of set operation (when it is started or a record of managed copy content is played), stored in a memory 213, and used.

The apparatus serial N is serial number specific to the information processing apparatus 200 which is generated and written when the information processing apparatus 200 is manufactured. The apparatus serial N is also shown as character information on the main body 201 of the information processing apparatus 200. On the other hand, the Seed A and the device key Ka are stored only in the nonvolatile memory 212.

The Seed P is identification information specific to this firmware, that is to say, common to a generation of the information processing apparatus 200. The Seed P is used, for example, to generate a device key Ka together with the Seed A, to encrypt the Seed A to generate encrypted Seed A′ or the like. As identification information common to the generation of the information processing apparatus 200, the Seed P may also be stored as non-rewritable information in the nonvolatile memory 212 at the time of manufacturing.

The URL of the server apparatus 300 is used to connect the information processing apparatus 200 through the network 101 to the server apparatus 300.

The content encryption/decryption section 280 performs managed copying or processing to play managed copied contents. To be specific, the content encryption/decryption section 280 encrypts a content C recorded in the removable recording medium 251 with the device key Ka stored in the nonvolatile memory 212, and generates an encrypted content C′. The content encryption/decryption section 280 records the encrypted content C′ in the external storage apparatus 260. Further, the content encryption/decryption section 280 decrypts the encrypted content C′ recorded in the external storage apparatus 260 with the device key Ka, and generates (restores) the content C. The content encryption/decryption section 280 performs predetermined processing on the decrypted content C, and supplies it to the AV equipment 216 through the analog output terminal 214 or the digital output terminal 215. With this, the AV equipment 216 supplies the content and users can view the content.

The key generation section 281 performs processing such as of generating a device key Ka using the Seed A and the Seed P stored in the nonvolatile memory 212, and recording the generated device key Ka in the nonvolatile memory 212.

The identification information encryption section 282 performs processing such as of encrypting the Seed A stored in the nonvolatile memory 212 with an apparatus common key such as Seed P, and generating encrypted Seed A′.

The transmission section 221 performs processing such as of transferring the encrypted Seed A′ generated by the identification information encryption section 282 and the apparatus serial N′ stored in the nonvolatile memory 212 through the network 101 to the server apparatus 300, and uploading them.

The reception section 222 performs processing such as of acquiring from the server apparatus 300 through the network 101 the encrypted Seed A′, and downloading it.

The identification information decryption section 283 performs processing such as of generating (restoring) the Seed A by decrypting the encrypted Seed A′ downloaded by the server apparatus 300 in the reception section 222 with the apparatus common key such as Seed P, and writing the generated Seed A in the nonvolatile memory 212.

### [Functional Configuration of Server Apparatus]

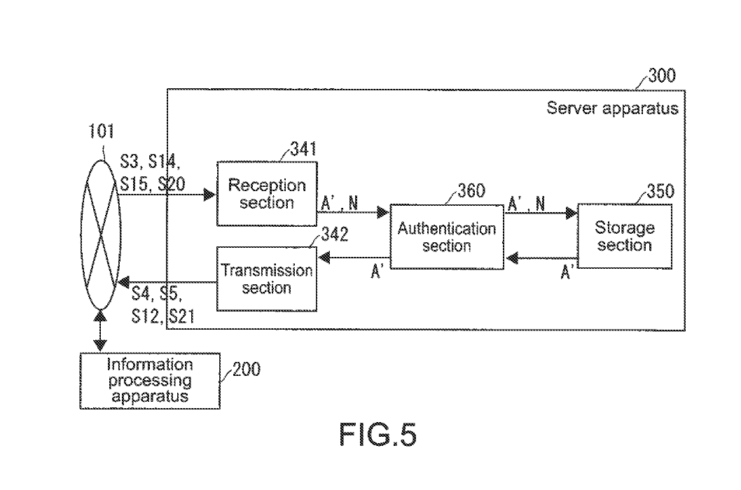

FIG. 5 is a block diagram showing a functional configuration of the server apparatus.

The server apparatus 300 includes the reception section 341, the storage section 350, an authentication section 360, and a transmission section 342.

The reception section 341 acquires the encrypted Seed A′ and the apparatus serial N through the network 101 from the information processing apparatus 200 for uploading.

In the storage section 350, a list E is stored. In the list E, the encrypted Seed A′ specific to each of the one or more information processing apparatuses 200 and the apparatus serial N are associated each other and stored. The storage section 350 associates the encrypted Seed A′ and the apparatus serial N, which are acquired by the reception section 341, each other and stores them in the list E.

The authentication section 360 judges whether the apparatus serial N acquired by the reception section 341 is stored in the list E of the storage section 350. The authentication section 360 performs processing such as of associating the authenticated apparatus serial N with the encrypted Seed A′ acquired by the reception section 341, and recording them in the list E stored in the storage section 350.

The transmission section 342 performs processing such as of supplying the encrypted Seed A′, which is recorded in the storage section 350 while being associated with the serial N authenticated by the authentication section 360, through the network 101 to the information processing apparatus 200 for downloading.

### [Process of Generating Device Key]

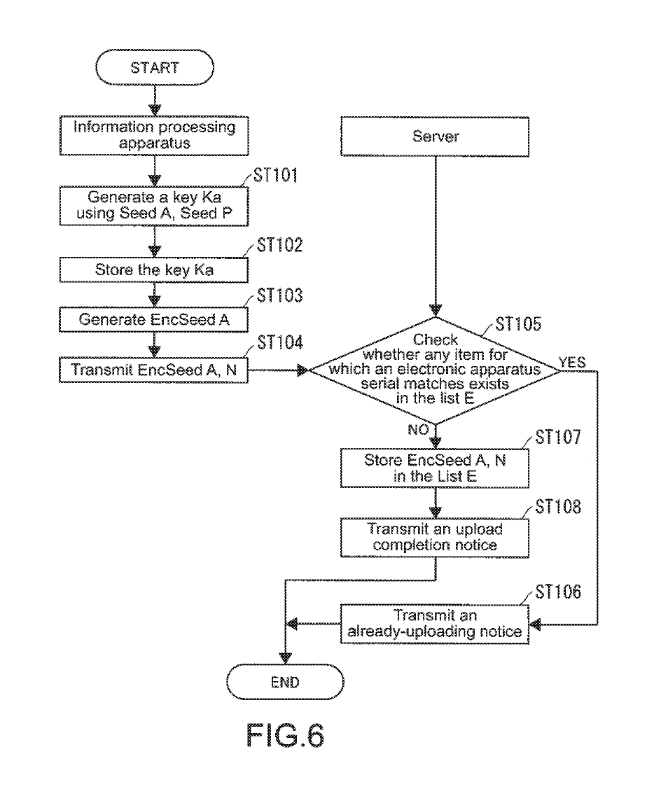

FIG. 6 is a flow chart showing a process of generating the device key.

In the nonvolatile memory 212 of the board 210 of the information processing apparatus 200, the Seed A, the apparatus serial N, the Seed P, the URL are stored.

In the storage section 350 of the server apparatus 300, the list E is stored.

First, the key generation section 281 acquires the Seed A and the Seed P stored in the nonvolatile memory 212, and generates a device key Ka using the acquired Seed A and Seed P (step ST101). The key generation section 281 stores the generated device key Ka in the nonvolatile memory 212 (step ST102).

As the device key Ka is stored in the nonvolatile memory 212, the content encryption/decryption section 280 can encrypt the content C recorded in the recording medium 251 with the device key Ka, generate an encrypted content C′, and record the encrypted content C′ in the external storage apparatus 260. Further, the content encryption/decryption section 280 can decrypt the encrypted content C′ stored in the external storage apparatus 260 with the device key Ka, and generate (restore) the content C.

Then, the key generation section 281 supplies to the identification information encryption section 282 an encrypted Seed generation instruction S1. Upon receipt of the encrypted Seed generation instruction S1, the identification information encryption section 282 generates the encrypted Seed A′ by encrypting the Seed A stored in the nonvolatile memory 212 with the apparatus common key such as Seed P (step ST103). The identification information encryption section 282 supplies the generated encrypted Seed A′ and the apparatus serial N stored in the nonvolatile memory 212 to the transmission section 221. The transmission section 221 acquires from the identification information encryption section 282 the encrypted Seed A′ and the apparatus serial N.

Then, the identification information encryption section 282 supplies an encrypted Seed generation completion notice S2 to the key generation section 281. Upon receipt of the encrypted Seed generation completion notice S2, the key generation section 281 instructs the transmission section 221 to transmit an encrypted Seed upload request S3 containing the encrypted Seed A′ and the apparatus serial N to the server apparatus 300. Upon receipt of the instruction, the transmission section 221 transfers the encrypted Seed upload request S3 containing the encrypted Seed A′ and the apparatus serial N through the network 101 to the server apparatus 300 (step ST104).

The reception section 341 of the server apparatus 300 supplies the encrypted Seed A′ and the apparatus serial N, which are contained in the encrypted Seed upload request S3 acquired from the information processing apparatus 200, to the authentication section 360.

The authentication section 360 judges whether the apparatus serial N acquired from the reception section 341 is recorded in the list E of the storage section 350 (step ST105). If the authentication section 360 judges that the apparatus serial N is recorded in the list E (Yes in step ST105), the authentication section 360 instructs the transmission section 342 to transmit an already-uploading notice S4 to the information processing apparatus 200. Following the instruction, the transmission section 342 transmits the already-uploading notice S4 through the network 101 to the information processing apparatus 200 (step ST106).

On the other hand, if the authentication section 360 judges that the apparatus serial N is not recorded in the list E (No in step ST105), the authentication section 360 associates the apparatus serial N and the encrypted Seed A′, which are acquired from the reception section 341, each other, and records them in the list E stored in the storage section 350 (step ST107). After the authentication section 360 records the apparatus serial N and the encrypted Seed A′ in the list E, the authentication section 360 instructs the transmission section 342 to transmit an upload completion notice S5 to the information processing apparatus 200. Following the instruction, the transmission section 342 transmits the upload completion notice S5 through the network 101 to the information processing apparatus 200 (step ST108).

### [Process of Restoring Seed A]

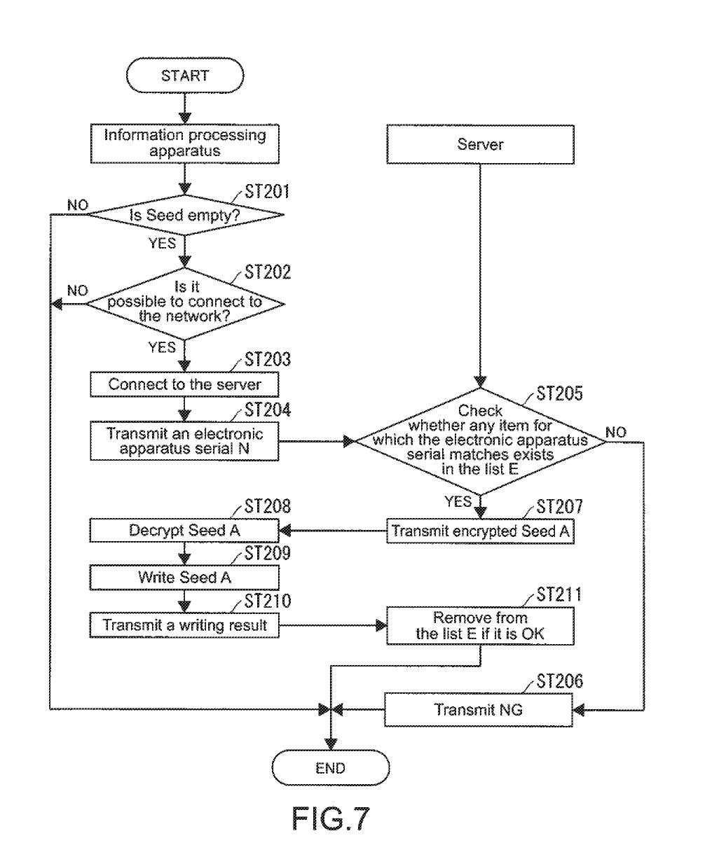

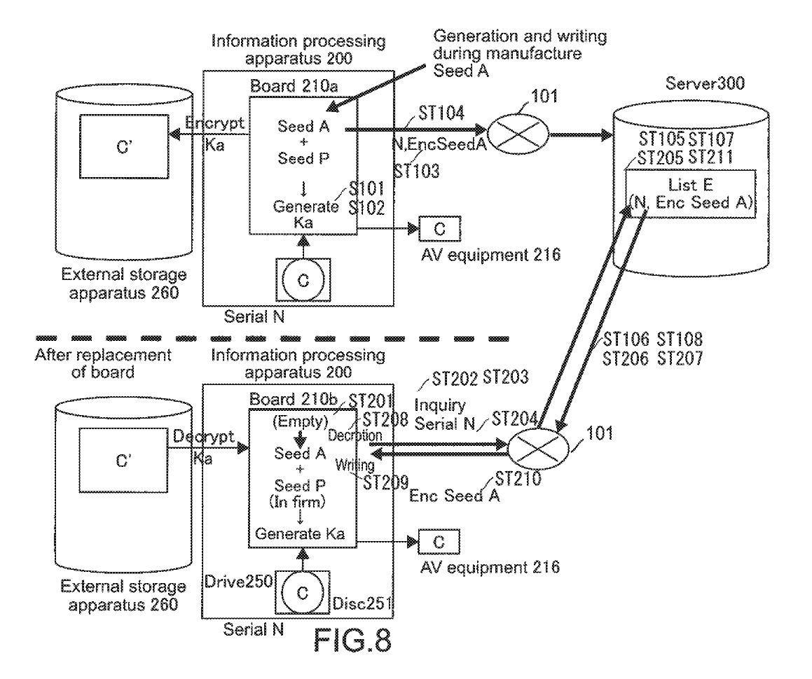

In the following description, the board 210 before being replaced will be described as “the board 210a before replacement”, and the board 210 after being replaced as “the board 210b after replacement”. FIG. 7 is a flow chart showing a process of restoring the Seed A. FIG. 8 is a schematic view showing the information processing system.

The board 210b after replacement is mounted on the information processing apparatus 200. In the nonvolatile memory 212 of the board 210b after replacement, the apparatus serial N, the Seed P, and the URL are recorded. The apparatus serial N is common to the board 210a before replacement and the board 210b after replacement. That is to say, an apparatus serial N stored in the nonvolatile memory 212 of the board 210a before replacement is written to the nonvolatile memory 212 of the board 210b after replacement by an operator of a repair factory when the information processing apparatus 200 is repaired. The Seed P is identification information specific to a firmware. The embodiment does not assume version upgrade of the firmware due to replacement of the board 210. Thus, in the following, the Seed P stored in the nonvolatile memory 212 of the board 210a before replacement and the Seed P stored in the nonvolatile memory 212 of the board 210b after replacement are the same.

On the other hand, in the list E stored in the storage section 350 of the server apparatus 300, the encrypted Seed A′ which resulted from encryption of the Seed A specific to the board 210a before replacement and the apparatus serial N of the information processing apparatus 200 to which the board 210a before replacement was mounted are associated each other and recorded. The encrypted Seed A′ and the apparatus serial N are those that were uploaded in step ST107 when the information processing apparatus 200 to which the board 210a before replacement was mounted performed the process of generating the device key mentioned above.

In order to perform the process of restoring the Seed A, first, the key generation section 281 of the information processing apparatus 200 judges whether no Seed A is stored in the nonvolatile memory 212 (step ST201). If the key generation section 281 judges that no Seed A is stored in the nonvolatile memory 212 (Yes in step ST201), the key generation section 281 transmits a network connection instruction S10 to the transmission section 221.

Upon receipt of the network connection instruction S10, the transmission section 221 performs a connection to the server apparatus 300 through the network 101. The transmission section 221 supplies a result of connection availability S11 to the key generation section 281. On the basis of the result of connection availability S11, the key generation section 281 judges whether it is possible to connect to the server apparatus 300 through the network 101 (step ST202). If the key generation section 281 judges that it is possible to connect to the server apparatus 300 through the network 101 (Yes in step ST202), the key generation section 281 connects to the server apparatus 300 (step ST203). It should be noted that the key generation section 281 judges that it may be impossible to connect to the server apparatus 300 (No in step ST202), the key generation section 281 terminates the process. Alternatively, the key generation section 281 may repeatedly perform judgments of whether it is possible to connect to the server apparatus 300 until the key generation section 281 judges that it is possible to connect to the server apparatus 300.

Then, the key generation section 281 instructs the transmission section 221 to transmit an encrypted Seed download request S15 containing the apparatus serial N stored in the nonvolatile memory 212 to the server apparatus 300. Following the instruction, the transmission section 221 transmits the encrypted Seed download request S15 containing the apparatus serial N through the network 101 to the server apparatus 300 (step ST204).

The reception section 341 of the server apparatus 300 supplies the apparatus serial N contained in the encrypted Seed download request S15 acquired from the information processing apparatus 200 to the authentication section 360.

The authentication section 360 judges whether the apparatus serial N acquired from the reception section 341 is recorded in the list E of the storage section 350 (step ST205). If the authentication section 360 judges that the apparatus serial N is not recorded in the list E (No in step ST205), the authentication section 360 instructs the transmission section 342 to transmit an authentication NG notice S12 to the information processing apparatus 200. Following the instruction, the transmission section 342 transmits the authentication NG notice S12 of the apparatus serial N through the network 101 to the information processing apparatus 200 (step ST206).

On the other hand, if the authentication section 360 judges that the apparatus serial N is recorded in the list E (Yes in step ST205), the authentication section 360 supplies the encrypted Seed A′ recorded in the list E while being associated with this apparatus serial N to the transmission section 342. The transmission section 342 acquires from the authentication section 360 the encrypted Seed A′, and supplies it to the information processing apparatus 200 through the network 101 (step ST207).

The reception section 222 of the information processing apparatus 200 acquires the encrypted Seed A′ from the server apparatus 300 through the network 101, and supplies the acquired encrypted Seed A′ to the identification information decryption section 283. The identification information decryption section 283 generates (restores) the Seed A by decrypting the encrypted Seed A′ acquired from the reception section 222 with the apparatus common key such as Seed P (step ST208), and stores the generated Seed A in the nonvolatile memory 212 (step ST209).

As the Seed A is stored in the nonvolatile memory 212, the information processing apparatus 200 can generate the device key Ka using the Seed A and the Seed P by the process of generating the device key (steps ST101 to ST108) mentioned above.

When the identification information decryption section 283 stores the Seed A in the nonvolatile memory 212, the identification information decryption section 283 supplies a download completion notice S13 to the key generation section 281. Upon receipt of the download completion notice S13, the key generation section 281 instructs the transmission section 221 to transmit, to the server apparatus 300, a completion notice S14 containing completion information of restoration of the Seed A with respect to the nonvolatile memory 212 and the apparatus serial N. Following the instruction, the transmission section 221 transmits the completion notice S14 containing the completion information of restoration of the Seed A with respect to the nonvolatile memory 212 and the apparatus serial N, through the network 101 to the server apparatus 300 (step ST210).

The reception section 341 of the server apparatus 300 acquires the completion notice S14 through the network 101 from the information processing apparatus 200, and supplies it to the authentication section 360.

When the authentication section 360 acquires from the reception section 341 the completion notice S14, the authentication section 360 removes, from the list E, the apparatus serial N contained in this completion notice S14 and the encrypted Seed A′ recorded while being associated with this apparatus serial N (step ST211).

It should be noted that if the key generation section 281 judges in step ST201 that the Seed A is stored in the nonvolatile memory 212, (No in step ST201), the key generation section 281 terminates the process. The case where the Seed A is stored in the nonvolatile memory 212 means a case where the board 210 is the board 210a before replacement or the process of restoring the Seed A has already been completed even if the board 210 is the board 210b after replacement.

According to this embodiment, the Seed A being the identification information specific to the board 210a before replacement to be used to generate the device key Ka specific to the board 210a before replacement is uploaded as the encrypted Seed A′ into the server apparatus 300. Consequently, the information processing apparatus 200 to which the board 210b after replacement is mounted can generate (restore) the Seed A by downloading and decrypting the encrypted Seed A′, and generate the device key Ka on the basis of the restored Seed A. Therefore, the information processing apparatus 200 to which the board 210b after replacement is mounted can also perform managed copying or play managed copied contents, by using the device key Ka specific to the board 210a before replacement. In addition, as the device key Ka itself is neither transferred through the network 101 nor stored in the server apparatus 300, the device key Ka will not leak from the information processing apparatus 200. Should the encrypted Seed A′ leak, the device key Ka may not be generated unless the encrypted Seed A′ can be decrypted and the Seed P can be acquired. Hence, it is safe.

In addition, the apparatus serial N being the serial number specific to the information processing apparatus 200 and the Seed A are associated each other and uploaded in the server apparatus 300, and hence the information processing apparatus 200 to which the board 210b after replacement is mounted can download the Seed A specific to the board 210a before replacement easily and accurately. It should be noted that the apparatus serial N is not limited to the serial number which is generated and written when the information processing apparatus 200 is manufactured, and that any apparatus serial N may be used unless it is the identification information specific to the information processing apparatus 200.

In addition, the information processing apparatus 200 to which the board 210b after replacement is mounted can generate the device key Ka by using the restored Seed A and the Seed P recorded in the firmware of the information processing apparatus 200.

### <Second Embodiment>

In the following, the description of any configuration and function or the like similar to those of the first embodiment will be simplified or omitted, and differences will be mainly described.

To the information processing apparatus 200, the board 210b after replacement is mounted. Suppose that, before that, to the information processing apparatus 200, the board 210a before replacement was mounted, and the process of generating the device key (steps ST101 to ST108) mentioned above was performed by using the Seed A specific to the board 210a before replacement.

### [Functional Configuration of Information Processing Apparatus]

The nonvolatile memory 212 rewritably stores Seed B (fourth identification information) and an apparatus serial N (second identification information). The nonvolatile memory 212 further stores a flag H indicating that it is a board after replacement. The nonvolatile memory 212 further stores the Seed P (third identification information) and the URL of the server apparatus 300 while being written in the firmware which controls the board 210.

The Seed B is identification information specific to the board 210b after replacement, and is generated and written when the board 210b after replacement is manufactured. The Seed B is used to download the encrypted Seed A′ from the server apparatus 300 through the network 101.

The flag H indicating that it is a board after replacement is generated when the board 210b after replacement is manufactured, and written in one time write area of the nonvolatile memory 212.

The identification information encryption section 282 performs processing such as of encrypting the Seed B stored in the nonvolatile memory 212 with the apparatus common key such as Seed P, and generating encrypted Seed B′.

The transmission section 221 performs processing such as of transmitting the encrypted Seed B′ and the apparatus serial N to the server apparatus 300 through the network 101 for authentication necessary for downloading of the encrypted Seed A′.

The identification information decryption section 283 performs processing such as of rewriting the Seed B stored in the nonvolatile memory 212 to the downloaded and restored Seed A.

### [Functional Configuration of Server Apparatus]

In the storage section 350, the list E and a list F are stored. In the list E, the encrypted Seed A′ which resulted from encryption of the Seed A specific to the board 210a before replacement and the apparatus serial N of the information processing apparatus 200 to which the board 210a before replacement was mounted are associated each other and recorded. In the list F, the encrypted Seed B′ which resulted from encryption of the Seed B specific to the board 210b after replacement is recorded. The encrypted Seed B′ is supplied through the network 101 to the server apparatus 300 when the board 210b after replacement is manufactured, and recorded in the list F stored in the storage section 350.

The reception section 341 performs processing such as of acquiring the encrypted Seed B′ and the apparatus serial N through the network 101 from the information processing apparatus 200 for authentication necessary for downloading of the encrypted Seed A′.

The authentication section 360 performs processing such as of judging whether the encrypted Seed B′ acquired from the reception section 341 is recorded in the list F of the storage section 350.

### [Process of Restoring Seed A]

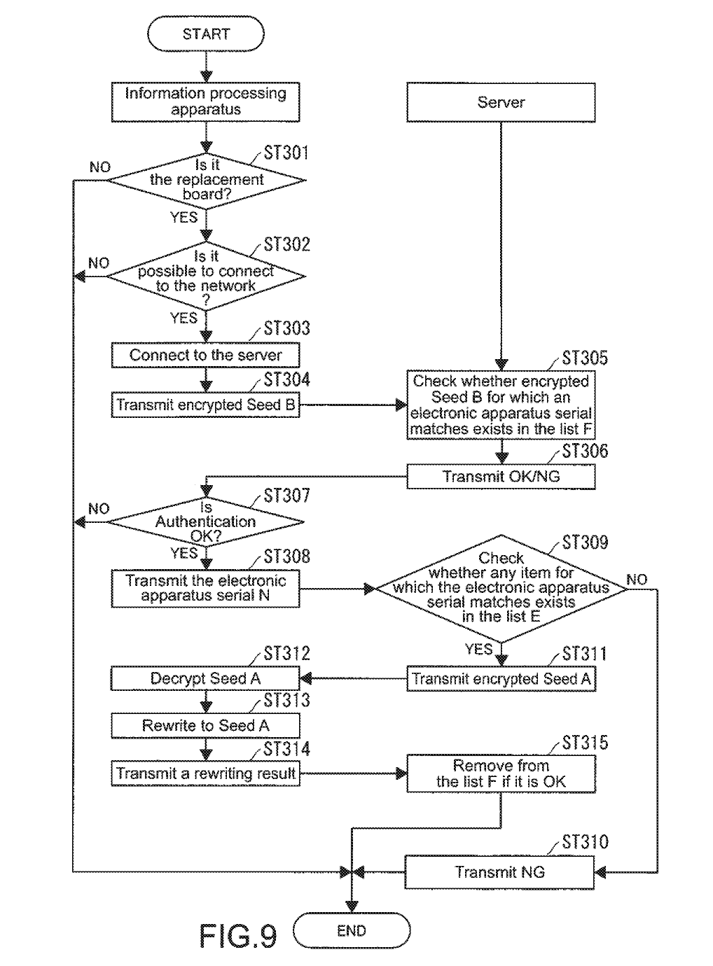

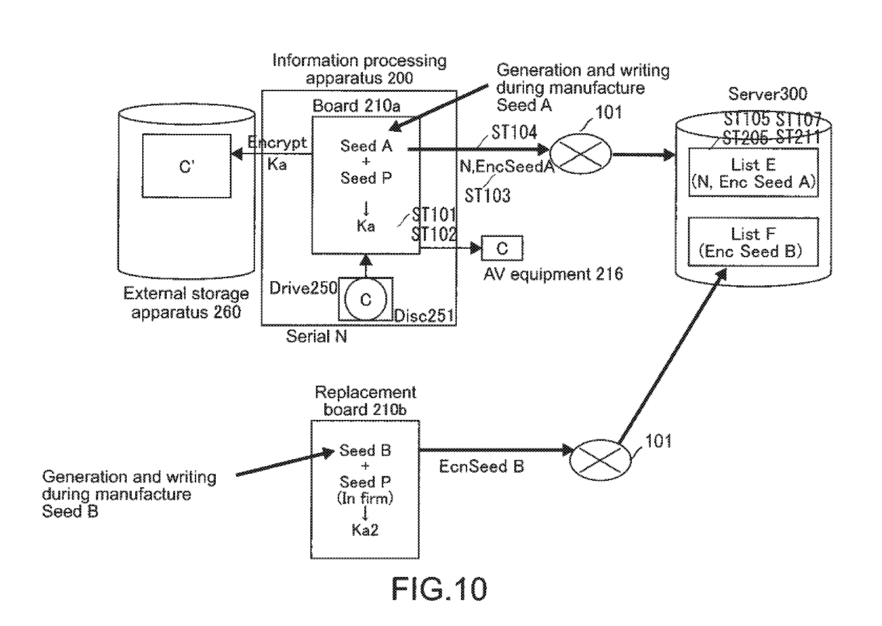

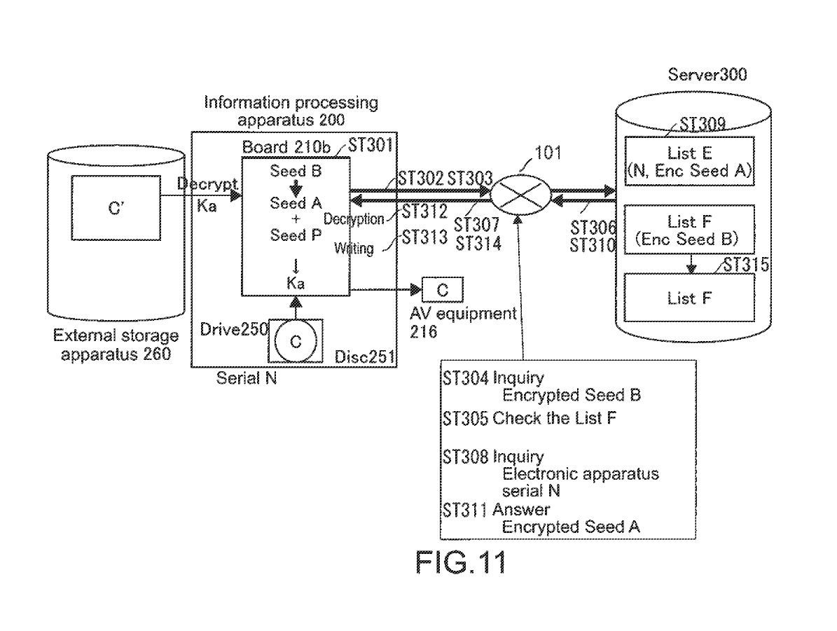

FIG. 9 is a flow chart showing a process of restoring the Seed A according to a second embodiment of the present disclosure. FIG. 10 is a schematic view showing the information processing system before replacement of the board. FIG. 11 is a schematic view showing the information processing system after replacement of the board.

To the information processing apparatus 200, the board 210b after replacement is mounted. In the nonvolatile memory 212 of the board 210b after replacement, the apparatus serial N, the Seed B, the flag H indicating whether or not it is a board after replacement, the Seed P, and the URL are stored.

On the other hand, in the storage section 350 of the server apparatus 300, the list E and the list F are stored. In the list E, the encrypted Seed A′ which resulted from encryption of the Seed A specific to the board 210a before replacement and the apparatus serial N of the information processing apparatus 200 to which the board 210a before replacement was mounted are associated each other and recorded. In the list F, the encrypted Seed B′ which resulted from encryption of the Seed B specific to the board 210b after replacement is recorded.

In order to perform the process of restoring the Seed A, first, the key generation section 281 of the information processing apparatus 200 judges whether or not the flag H stored in the nonvolatile memory 212 indicates that it is the board 210b after replacement (step ST301). If the key generation section 281 judges that the flag H indicates that it is the board 210b after replacement (Yes in step ST301), the key generation section 281 supplies to the transmission section 221 the network connection instruction S10. On the other hand, if the key generation section 281 judges that the flag H does not indicate that it is the board 210b after replacement (No in step ST301), the key generation section 281 terminates the process.

Then, the same process as in steps ST202 to ST203 mentioned above is performed (steps ST302 to ST303).

Then, the key generation section 281 supplies to the identification information encryption section 282 the encrypted Seed generation instruction S1. Upon receipt of the encrypted Seed generation instruction S1, the identification information encryption section 282 generates the encrypted Seed B′ by encrypting the Seed B stored in the nonvolatile memory 212 with the apparatus common key such as Seed P. The identification information encryption section 282 supplies the generated encrypted Seed B′ and the apparatus serial N stored in the nonvolatile memory 212 to the transmission section 221. The transmission section 221 acquires from the identification information encryption section 282 the encrypted Seed B′ and the apparatus serial N.

Then, the identification information encryption section 282 supplies the encrypted Seed generation completion notice S2 to the key generation section 281. Upon receipt of the encrypted Seed generation completion notice S2, the key generation section 281 instructs the transmission section 221 to transmit an encrypted Seed authentication request S20 containing the encrypted Seed B′ and the apparatus serial N to the server apparatus 300. Following the instruction, the transmission section 221 transmits the encrypted Seed authentication request S20 containing the encrypted Seed B′ and the apparatus serial N through the network 101 to the server apparatus 300 (step ST304).

The reception section 341 of the server apparatus 300 supplies the encrypted Seed B′ and the apparatus serial N, which are contained in the encrypted Seed authentication request S20 acquired from the information processing apparatus 200, to the authentication section 360.

The authentication section 360 judges whether the encrypted Seed B′ acquired from the reception section 341 is recorded in the list F of the storage section 350 (step ST305). If the authentication section 360 judges that the encrypted Seed B′ is recorded in the list F, the authentication section 360 instructs the transmission section 342 to transmit an authentication OK notice S21 to the server apparatus 300. Following the instruction, the transmission section 342 transmits the authentication OK notice S21 through the network 101 to the information processing apparatus 200 (step ST306).

On the other hand, if the authentication section 360 judges that the encrypted Seed B′ is not recorded in the list F, the authentication section 360 instructs the transmission section 342 to transmit the authentication NG notice S12 to the server apparatus 300. Following the instruction, the transmission section 342 transmits the authentication NG notice S12 through the network 101 to the information processing apparatus 200 (step ST306).

The reception section 222 of the information processing apparatus 200 acquires the authentication OK notice S21 or the authentication NG notice S12 from the server apparatus 300 and supplies it to the key generation section 281. The key generation section 281 judges which one of the authentication OK notice S21 and the authentication NG notice S12 the notice acquired from the reception section 222 is (step ST307).

If the notice acquired by the key generation section 281 is judged as being the authentication OK notice S21 (Yes in step ST307), the same process as in steps ST204 to ST208 mentioned above is performed (steps ST308 to step ST312). It should be noted that if the key generation section 281 judges that the acquired notice is the authentication NG notice S12 (No in step ST307), the key generation section 281 rewrites the flag H to a flag indicating that it is the board 210b after replacement, writes the fact that it is the board 210b after replacement to the nonvolatile memory 212, and terminates the process.

The identification information decryption section 283 rewrites the Seed B stored in the nonvolatile memory 212 to the Seed A generated in step ST312 by the identification information decryption section 283 (step ST313).

As the Seed A is stored in the nonvolatile memory 212, the information processing apparatus 200 can generate the device key Ka using the Seed A and the Seed P by the process of generating the device key (steps ST101 to ST108) mentioned above.

When the identification information decryption section 283 writes the Seed A in the nonvolatile memory 212, the identification information decryption section 283 supplies to the key generation section 281 the download completion notice S13 indicating that the Seed A is stored in the nonvolatile memory 212. Upon receipt of the download completion notice S13, the key generation section 281 instructs the transmission section 221 to transmit the completion notice S14 containing the completion information of restoration of the Seed A with respect to the nonvolatile memory 212 and the apparatus serial N, to the server apparatus 300. In addition, the key generation section 281 rewrites the flag H to the flag indicating that it is the board 210b after replacement, and writes the fact that it is the board 210b after replacement in the nonvolatile memory 212. Following the instruction, the transmission section 221 transmits the completion notice S14 containing the completion information of restoration of the Seed A with respect to the nonvolatile memory 212 and the apparatus serial N, through the network 101 to the server apparatus 300 (step ST314).

The reception section 341 of the server apparatus 300 acquires the completion notice S14 through the network 101 from the information processing apparatus 200, and supplies it to the authentication section 360.

When the authentication section 360 acquires from the reception section 341 the completion notice S14, the authentication section 360 removes, from the list F, the apparatus serial N contained in this completion notice S14 and the encrypted Seed B′ recorded while being associated with this apparatus serial N (step ST315).

According to this embodiment, the authentication is performed by using the encrypted Seed B′ which resulted from encryption of the Seed B being the identification information specific to the board 210b after replacement, and hence it is possible to authenticate that the board 210b after replacement is not falsified one or the like, but authentic one before performing downloading of the encrypted Seed A′. It should be noted that even if the information processing apparatus 200 to which the board 210b after replacement is mounted is not connected to the network 101, it is also possible to newly generate a device key Ka2 different from the device key Ka, using the Seed B and the Seed P, which are recorded in the board 210b after replacement.

### <Third Embodiment>

In the following, the description of any configuration and function or the like similar to those of the first embodiment and the second embodiment will be simplified or omitted, and differences will be mainly described.

To the information processing apparatus 200, the board 210b after replacement is mounted. Suppose that, before that, to the information processing apparatus 200, the board 210a before replacement was mounted, and the process of generating the device key (steps ST101 to ST108) mentioned above was performed by using the Seed A specific to the board 210a before replacement.

### [Functional Configuration of Information Processing Apparatus]

The nonvolatile memory 212 rewritably stores Seed B (fourth identification information) and the apparatus serial N (second identification information). The nonvolatile memory 212 further stores board identification information P (fifth identification information) and the flag H indicating that it is a board after replacement. The nonvolatile memory 212 further stores the Seed P (third identification information) and the URL of the server apparatus 300 while being written in a firmware which controls the board 210.

The board identification information P is identification information specific to the board 210b after replacement, which is to be identified by use of the Seed B, and is generated and written when the board 210b after replacement is manufactured.

The transmission section 221 performs processing such as of transmitting the encrypted Seed B′ and the board identification information P to the server apparatus 300 through the network 101 for authentication necessary for downloading of the encrypted Seed A′.

### [Functional Configuration of Server Apparatus]

In the storage section 350, the list E is stored. In the list E, the Seed A′ which resulted from encryption of the Seed A specific to the board 210a before replacement and the apparatus serial N of the information processing apparatus 200 to which the board 210a before replacement was mounted are associated each other and recorded. In the list E, the encrypted Seed B′ which resulted from encryption of the Seed B specific to the board 210b after replacement and the board identification information P of the board 210b after replacement are also associated each other and recorded. The encrypted Seed B′ and the board identification information P are supplied through the network 101 to the server apparatus 300 when the board 210b after replacement is manufactured, and recorded in the list E stored in the storage section 350.

The reception section 341 performs processing such as of acquiring the encrypted Seed B′ and the board identification information P through the network 101 from the information processing apparatus 200 for authentication necessary for downloading of the encrypted Seed A′.

The authentication section 360 performs processing such as of judging whether the encrypted Seed B′ and the board identification information P acquired from the reception section 341 are associated each other and recorded in the list E of the storage section 350.

### [Process of Restoring Seed A]

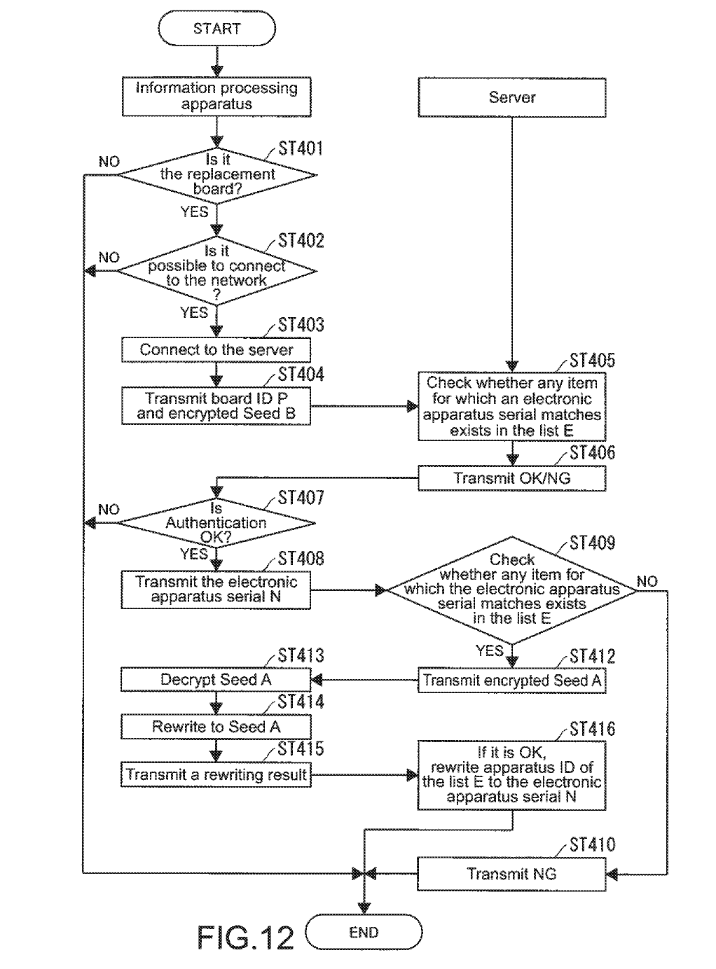

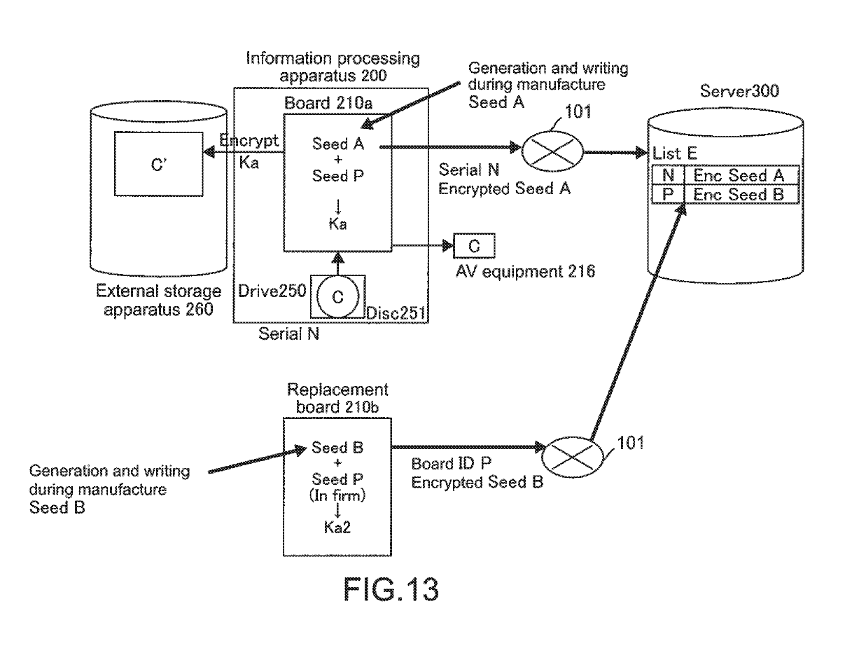

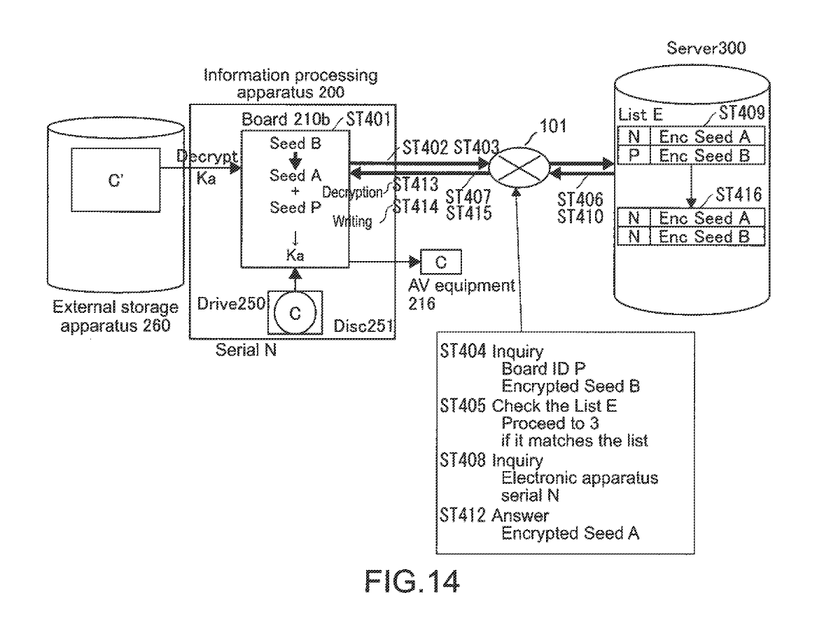

FIG. 12 is a flow chart showing a process of restoring the Seed A according to a third embodiment of the present disclosure. FIG. 13 is a schematic view showing the information processing system before replacement of board. FIG. 14 is a schematic view showing the information processing system after replacement of board.

To the information processing apparatus 200, the board 210b after replacement is mounted. In the nonvolatile memory 212 of the board 210b after replacement, the apparatus serial N, the Seed B, the board identification information P (fifth identification information), the flag H indicating that it is a board after replacement, the Seed P, and the URL are stored.

On the other hand, in the storage section 350 of the server apparatus 300, the list E is stored. In the list E, the Seed A′ which resulted from encryption of the Seed A specific to the board 210a before replacement and the apparatus serial N of the information processing apparatus 200 to which the board 210a before replacement was mounted are associated each other and recorded. In the list E, the encrypted Seed B′ which resulted from encryption of the Seed B specific to the board 210b after replacement and the board identification information P of the board 210b after replacement are also associated each other and recorded.

First, the same process as in steps ST301 to ST303 mentioned above is performed (steps ST401 to ST403).

Then, the key generation section 281 supplies to the identification information encryption section 282 the encrypted Seed generation instruction S1. Upon receipt of the encrypted Seed generation instruction S1, the identification information encryption section 282 generates the encrypted Seed B′ by encrypting the Seed B stored in the nonvolatile memory 212 with the apparatus common key such as Seed P. The identification information encryption section 282 supplies the generated encrypted Seed B′ and the board identification information P stored in the nonvolatile memory 212 to the transmission section 221. The transmission section 221 acquires from the identification information encryption section 282 the encrypted Seed B′ and the board identification information P.

Then, the identification information encryption section 282 supplies the encrypted Seed generation completion notice S2 to the key generation section 281. Upon receipt of the encrypted Seed generation completion notice S2, the key generation section 281 instructs the transmission section 221 to transmit an encrypted Seed authentication request S20 containing the encrypted Seed B′ and the board identification information P through the network 101 to the server apparatus 300 (step ST404).

The reception section 341 of the server apparatus 300 supplies the encrypted Seed B′ and the board identification information P, which are contained in the encrypted Seed authentication request S20 acquired from the information processing apparatus 200, to the authentication section 360.

The authentication section 360 acquires the encrypted Seed B′ and the board identification information P from the reception section 341, and judges whether the encrypted Seed B′ and the board identification information P are associated each other and recorded in the list E of the storage section 350 (step ST405). If the authentication section 360 judges that the encrypted Seed B′ and the board identification information P are associated each other and recorded in the list E of the storage section 350, the authentication section 360 instructs the transmission section 342 to transmit an authentication OK notice S21 to the server apparatus 300. Following the instruction, the transmission section 342 transmits the authentication OK notice S21 through the network 101 to the information processing apparatus 200 (step ST406).

On the other hand, if the authentication section 360 judges that the encrypted Seed B′ and the board identification information P are not associated each other and recorded in the list E of the storage section 350, the authentication section 360 instructs the transmission section 342 to transmit the authentication NG notice S12 to the server apparatus 300. Following the instruction, the transmission section 342 transmits the authentication NG notice S12 through the network 101 to the information processing apparatus 200 (step ST406).

Then, the same process as in steps ST307 to ST313 mentioned above is preformed (steps ST407 to ST413).

As the Seed A is stored in the nonvolatile memory 212, the information processing apparatus 200 can generate the device key Ka using the Seed A and the Seed P by the process of generating the device key (steps ST101 to ST108) mentioned above.

The download completion notice S13 indicating that the Seed A is stored in the nonvolatile memory 212 is supplied to the key generation section 281. Upon receipt of the download completion notice S13, the key generation section 281 instructs the transmission section 221 to transmit the completion notice S14 containing the completion information of restoration of the Seed A with respect to the nonvolatile memory 212, the apparatus serial N, and the board identification information P, to the server apparatus 300. In addition, the key generation section 281 rewrites the flag H to a flag indicating that it is the board 210b after replacement, and writes the fact that it is the board 210b after replacement in the nonvolatile memory 212. Following the instruction from the key generation section 281, the transmission section 221 transmits the completion notice S14 containing the completion information of restoration of the Seed A with respect to the nonvolatile memory 212, the apparatus serial N, and the board identification information P, to the server apparatus 300 (step ST414).

The reception section 341 of the server apparatus 300 acquires the completion notice S14 through the network 101 from the information processing apparatus 200, and supplies it to the authentication section 360.

When the authentication section 360 acquires from the reception section 341 the completion notice S14, the authentication section 360 rewrites the board identification information P contained in the completion notice S14, which is recorded in the list E, to the apparatus serial N contained in the completion notice S14 (step ST415).

According to this embodiment, the authentication is performed by using the encrypted Seed B′ which resulted from encryption of the Seed B being the identification information specific to the board 210b after replacement and the board identification information P, and hence it is possible to authenticate that the board 210b after replacement is not falsified one or the like, but authentic one before performing downloading of the encrypted Seed A′.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a board on which electronic components are provided;
a content encryption section configured to encrypt a content with a device key;
a first storage section which is provided as one of the electronic components on the board and is capable of storing first identification information specific to the board, the first identification information being used to generate the device key;
a transfer section configured to transfer the first identification information through a network to a server apparatus capable of storing the first identification information; and
a first acquisition section configured to acquire ₜhe first identification information through the network from ₜhe server apparatus.

2. The information processing apparatus according to claim further comprising
an identification information encryption section configured to encrypt the first identification information; and
an identification information. decryption section configured to decrypt the encrypted first identification information, wherein
the transfer section transfers the encrypted first identification information through the network to the server apparatus, and
the first acquisition section acquires the first identification information through the network from the server apparatus.

3. The information processing apparatus according to claim 2, further comprising:
a second storage section configured to store second identification information specific to the information processing apparatus, wherein
the server apparatus is capable of associating the encrypted first identification information with the second identification information and storing the encrypted first identification information and the second identification information,
the transfer section further transfers the second identification information through the network to the server apparatus, and
the first acquisition section acquires the first identification information, which is encrypted by the server apparatus while being associated with the second identification information, through the network.

4. The information processing apparatus according to claim 3, wherein
the first storage section further stores third identification information specific to a firmware, and
the information processing apparatus further comprises a key generation section configured to generate the device key on a basis of the first identification information and the third identification information.

5. The information processing apparatus according to claim 4, wherein
the first storage section is capable of selectively storing the first identification information and fourth identification information specific to the board, the fourth identification information being used to acquire the encrypted first identification information through the network from the server apparatus,
the identification information encryption section further encrypts the fourth identification information stored in the first storage section, the server apparatus is further capable of storing the encrypted fourth identification information,
the transfer section transfers the second identification information through the network to the server apparatus when the transfer section further transfers the encrypted fourth identification information to the server apparatus through the network, and acquires an authentication of the encrypted. fourth identification information from the server apparatus, and
the first storage section further rewrites the fourth identification information stored in the first storage section to the first identification information.

6. The information processing apparatus according to claim 5, wherein
the first storage section is further capable of storing fifth identification information specific to the board to be identified by use of the fourth identification information,
the server apparatus is capable of associating the encrypted fourth identification information with the fifth identification information, and storing the encrypted fourth identification information and the fifth identification information, and
the transfer section associates the encrypted fourth identification information with the fifth identification information and transfers the encrypted fourth identification information and the fifth identification information through the network to the server apparatus.

7. A server apparatus connectable to an information processing apparatus including a board on which electronic components are provided, a content encryption section configured to encrypt a content with a device key, a first storage section which is provided as one of the electronic components on the board and is capable of storing first identification information specific to the board, the first identification information being used to generate the device key, and a second storage section configured to second identification information specific to the information processing apparatus, the server apparatus comprising_{:}
a third storage section capable of associating the first identification information and the second identification information each other and storing the first identification information and the second identification information;
a second acquisition section configured to acquire the second identification information. through a network from the information processing apparatus;
an authentication section configured to judge whether the acquired second identification information is stored in the third storage section; and
a supply section configured to supply the first identification information, which is stored in the third storage section. while being associated with the second identification information, through the network to the information processing apparatus when the authentication section judges that the acquired second identification information is stored in the third storage section.

8. An information processing method by an information processing apparatus including a board on which electronic components are provided, a content encryption section configured to encrypt a content with a device key, and a first storage section which is provided as one of ₜhe electronic components on the board and is capable of storing first identification information specific to the board, the first identification information being used to generate the device key, the method comprising_{:}
transferring the first identification information through a network to a server apparatus capable of storing the first identification information, by a transfer section; and
acquiring the first identification information through the network from the server apparatus by a first acquisition section.

9. A program causing an information processing apparatus including a board on which electronic components are provided, a content encryption section configured to encrypt a content with a device key, and a first storage section which is provided as one of the electronic components on the board and is capable of storing first identification information specific to the board, the first identification information being used to generate the device key, to function as:
a transfer section configured to transfer the first identification information through a network to a server apparatus capable of storing the first identification information; and
a first acquisition section configured to acquire the first identification information through the network from the server apparatus.
